(19) United States
(12) Patent Application Publication
(10) Pub. No.: US 2012/0307106 A1
(43) Pub. Date: Dec. 6, 2012

(54) Synchronized Exposures For An Image Capture System

(76) Inventors: Kurt Eugene Spears, Fort Collins, CO (US); Kenneth K. Smith, Boise, ID (US)

(21) Appl. No.: 13/118,964

(22) Filed: May 31, 2011

(51) Int. Cl. H04N 9/73

(52) U.S. Cl. 348/227.1; 348/E09.051

(57) ABSTRACT

An imaging system is disclosed. The imaging system has an image sensor and an illumination device. The imaging system captures two images, one with only ambient light, and the other with ambient light and light from the illumination device. The two images are synchronized such that the time between the start of the two image exposures is an integer multiple of at least one flicker period. The final image is created by subtracting the ambient only image from the other image.

### BACKGROUND

Image capture devices that are used to capture images illuminated with florescent lights may have image defects due to the flicker in the illumination from the florescent lights. Image capture devices that use a complementary metal-oxide-semiconductor (CMOS) sensor to capture the image may have the most image defects due to the rolling shutter used with the CMOS sensor.

### BRIEF DESCRIPTION OF THE DRAWINGS

FIG. 1 is a graph showing the cyclical illumination output from a florescent light.

FIG. 2 is a graph showing the cyclical illumination output from 2 different florescent lights being driven at different frequencies.

FIG. 3 is a side view of an image capture system 100 in an example embodiment of the invention.

FIG. 4 is a graph showing the timing for capturing two synchronized images, in an example embodiment of the invention.

### DETAILED DESCRIPTION

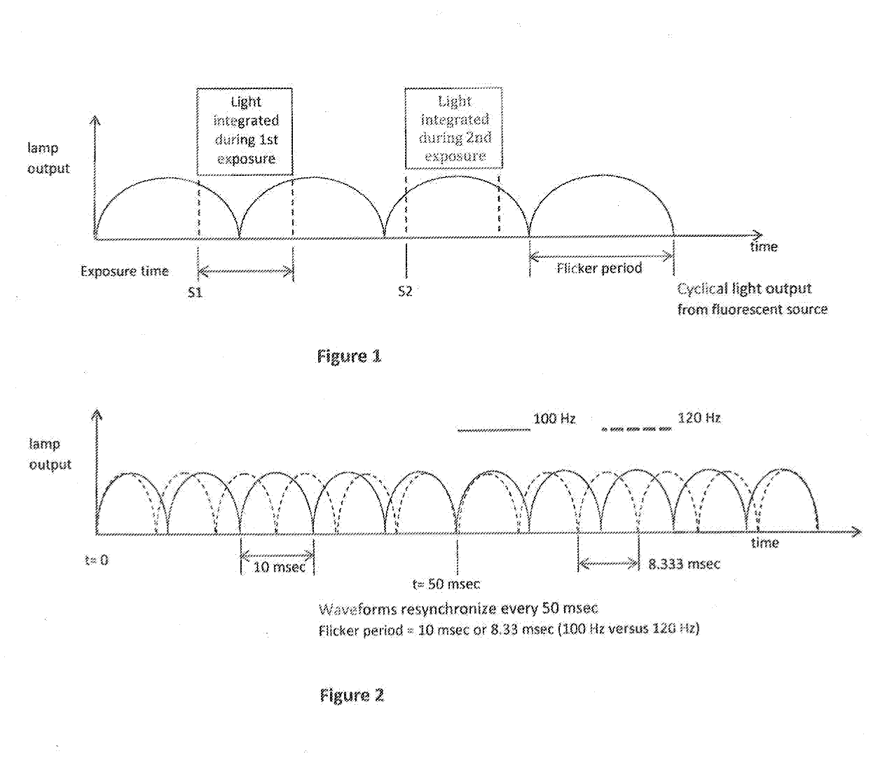

FIGS. 1-4, and the following description depict specific examples of the invention. For the purpose of teaching inventive principles, some conventional aspects have been simplified or omitted. Those skilled in the art will appreciate variations from these examples that fall within the scope of the invention. The features described below can be combined in various ways to form multiple variations of the invention. As a result, the invention is not limited to the specific examples described below, but only by the claims and their equivalents.

Fluorescent light fixtures use ballasts to drive the lamp at 2× the line frequency which results in a frequency of 100 Hz (on 50 Hz power systems) and 120 Hz (on 60 Hz power systems). The lamp output varies as the applied voltage cycles between the positive and negative voltages at the 2× frequency. FIG. 1 is a graph showing, the cyclical illumination output from a florescent light. In FIG. 1 the Y axis is the light output and the X axis is time. The light output varies over time with a flicker period based on the frequency that the lamp ballasts is being driven. Two different exposures are shown. The first exposure starts at time S1 with an exposure length that integrates light during the time when the light output from the lamp reaches a minimum. The second exposure starts at time S2 with an exposure length that integrates light during the time when the light output from the lamp reaches a maximum. The brightness of the image captured during the first exposure will be less than the brightness of the image captured during the second exposure, even though the exposure lengths (or integration times) for the two exposures are equal. This difference in brightness causes dark/light bands in the final image.

FIG. 2 is a graph showing the cyclical illumination output from 2 different florescent lights being driven at different frequencies. In FIG. 2 the Y axis is the light output and the X axis is time. The light output from the two lamps varies over time with a flicker period based on the frequency that the lamp ballasts is being driven. The first lamp is being driven at 100 Hz and its light output is shown with the solid line. The second lamp is being driven at 120 Hz and its light output is shown with the dashed line. The flicker period for the first lamp is 10 msec. The flicker period for the second lamp is 8.333 msec. The two flicker periods align every 50 msec.

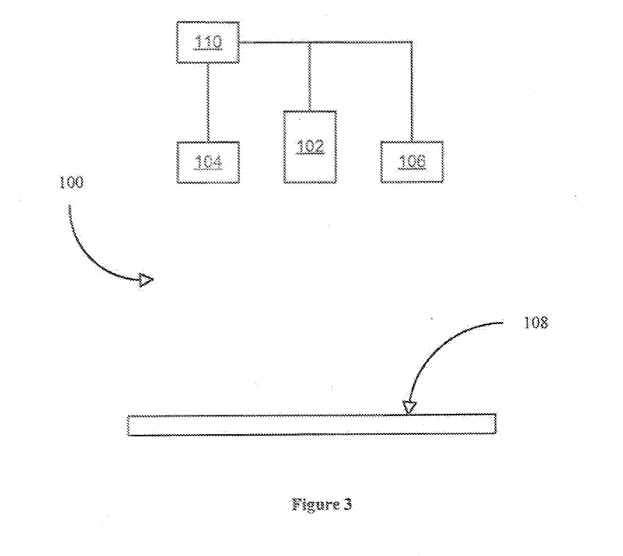

FIG. 3 is a side view of an image capture system 100 in an example embodiment of the invention. Image capture system 100 comprises image capture device 102, two illumination devices or light sources (104 and 106), controller 110 and platen 108. Image capture device 102 may be a camera, an image sensor, or the like. Illumination devices 104 and 106 may be a light emitting diode (LED), a flash, an incandescent bulb, or the like. Controller can be a processor based device configured to control the image capture device 102 and the two illumination devices 104 and 106. In some embodiments, controller 110 may be integrated into image capture device 102. Controller 110 may be an application specific integrated circuit (ASIC), programmable logic device, or code running on a microcontroller or microprocessor.

Image capture device 102 is mounted above a platen 108 for supporting a document or other object to be imaged. The document or other object to be imaged is not shown for clarity reasons. Device 102 is configured to capture an image of a document or other object placed onto platen 108. Illumination device 104 is mounted on one side of image capture device 102 and illumination device 106 is mounted on the other side of image capture device. In other example embodiments of the invention there may be only one illumination device mounted to, or in-line with, the image capture device. The two illumination devices are used to illuminate objects placed on platen 108 so that image capture device can capture an image of the object. In other embodiments, there may be more than two illumination devices.

Image capture device 102 may use a complementary metal-oxide-semiconductor (CMOS) sensor to capture the image of documents placed on the platen 108. CMOS sensors utilize a rolling shutter that moves across the sensor to capture images. The rolling shutter comprises a leading reset edge followed by a readout edge. The readout edge follows the reset edge by a time X. Time X is set based on the desired exposure time and the lighting conditions. Time X is typically in the millisecond (msec) range. The distance or time between the readout edge and the reset edge (Time X) is typically called the exposure length, the exposure time, the integration time, the shutter width or the like. In-between the reset edge and the readout edge is an exposure area. Each time the exposure area travels completely across the image sensor a single image is captured.

Image capture system 100 may be used in an area illuminated by florescent lights. When an image is captured by a camera with a rolling shutter, the flicker causes banding in the image if the shutter width or exposure time is not an integral multiple of the flicker cycle time (or flicker frequency). However, the existence of two unique power systems complicates the issue of determining the flicker cycle, time.

In one example embodiment of the invention, image capture system 100 will capture two images of the object/document placed on platen 108. One of the images will be captured using only the ambient light created by the florescent lights. The other image will be captured using the ambient light and light from the two illumination devices (104 and 106). The time at which the two images are captured will be synchronized to a multiple of the flicker period of the florescent lights. The image captured with just ambient light will be subtracted from the image captured with both ambient light and light from illumination devices 104 and 106 to form the final image. The order in which the two images are captured is not important. The image captured using only ambient light can be the first or second image captured. In one example embodiment of the invention, the light from the two illumination devices (104 and 106) will provide at least 2 times more illumination than just the ambient light. In another example embodiment of the invention, the light from the two illumination devices (104 and 106) will provide between 8 and 10 times more illumination than just the ambient light. In yet another example embodiment of the invention, the light from the two illumination devices (104 and 106) will provide more than 50 times the illumination than just the ambient light.

Because the start times of the two exposures are synchronized to a multiple of the flicker period of the florescent lights, the dark/light bands in each of the two images will be located at the same position. Because the dark/light bands are located in the same place in the two images, subtracting the image captured with only ambient light from the other image will eliminate the variation in brightness due to flicker.

A CMOS image sensor typically comprises N rows of pixels. An image is captured by sequentially exposing each row of pixels. The start of the exposure for each row of pixels corresponds to when a reset edge reaches the row of pixels. The exposure length is controlled by when the following readout edge reaches the row of pixels. The time it takes for the reset edge to travel from one row of pixels to the next row of pixels is called the slew time, and is typically a constant determined by the row readout time of the sensor.

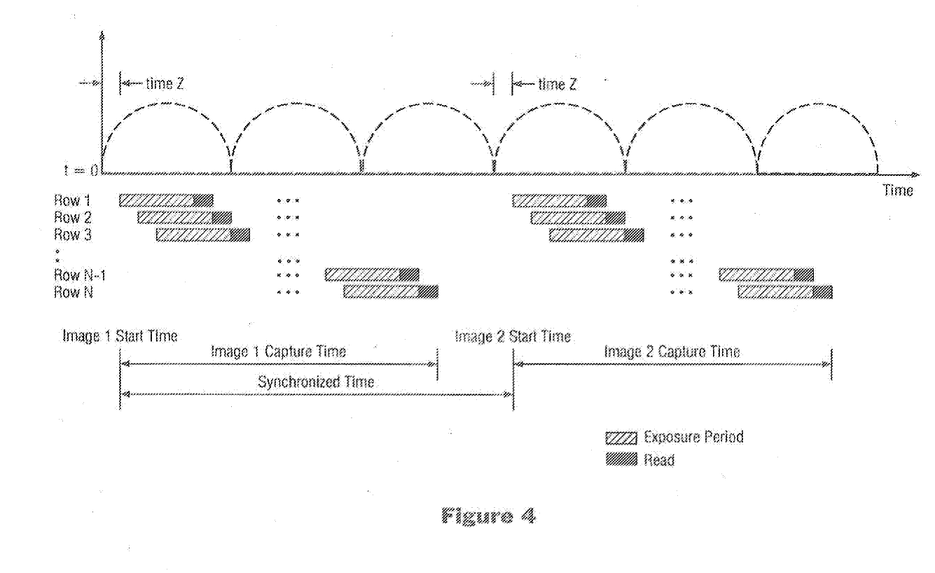

FIG. 4 is a graph showing the timing for capturing the two synchronized images, in an example embodiment of the invention. In FIG. 4 the Y axis is the light output and the X axis is time. The light output varies over time with a flicker period based on the frequency that the lamp ballasts is being driven. The first image is captured starting at “image 1 start time”. At “image 1 start time” the first row (row 1) of pixels in the image sensor starts collecting light. The exposure time for each row of pixels in the image sensor is shown as row, 1, row 2 . . . row N, where row N is the last row of pixels in the image sensor. The beginning of the exposure for row 2 is “slew time” after the image 1 start time. The beginning of the exposure for row N is equal to N * (slew time) after the image 1 start time. The exposure time is shown as being longer that the slew time such that multiple rows of pixels will be collecting light simultaneously but the exposure time may also be shorter than the slew time.

The second image is captured starting at a synchronized time after the image 1 start time. The slew time and the exposure time for the second image are the same as the slew time and the exposure time for the first image. The length of synchronized time is an integer multiple of the flicker period. Because the synchronized time is an integer multiple of the flicker period, the two image start times occur at the same position or phase of the flicker period. Time z is the time between the start of a flicker period and the image start time. Time z is the same for the image 1 start time and image 2 start time. Once the two images are captured, the ambient light image is subtracted from the other image, producing an image that is flicker free. The images are subtracted by taking the value for each pixel in the ambient light image and subtracting that value from the value of the same pixel in the second image.

There are two different flicker periods, one at 100 Hz and one at 120 Hz, depending on where the image capture device is located. In one example embodiment of the invention, the flicker period is determined and the synchronized time is set to an integer multiple of that flicker period. The flicker period can be determined in a number of different ways, for example by determining the geographical location of the device and using a table lookup to determine what is the AC Main power oscillation, by user input or the like. In another example embodiment of the invention, the synchronized time is set to a cycle time multiple of both of the two flicker periods. 50 msec is a cycle time multiple of both of the two flicker periods. When the synchronized time is set to an integer Multiple of 50 msec, the final image will be flicker free when the flicker period is either 100 Hz or 120 Hz.

Some low cost fluorescent ballasts have asymmetry between the two rectified phases. This asymmetry causes a doubling of the flicker period. In areas where low cost fluorescent ballasts may be present, using a synchronized time set to an integer multiple of 16.666 msec, 20 msec or 100 msec will eliminate the flicker for these types of fluorescent lights.

The description above, uses an image capture system were the image sensor is fixed above a platen where the object to be imaged is placed. However, this invention can also be used with a handheld image capture device, for example a digital camera, a cell phone, a PDA, a laptop, or the like. Any movement of the handheld image capture device between capturing the two images can be compensated for by image alignment between the two images, image stabilization during the image capture process or the like. Image alignment is done by spatially aligning the two images before subtraction.

What is claimed is:

1. A method for capturing an image, comprising:
capturing a first image of an object in ambient light with an image sensor that uses a rolling shutter, wherein the image sensor starts an exposure to capture the first image at a first time T1;
capturing a second image of the object with the image sensor, using auxiliary illumination in addition to the ambient light, wherein the image sensor starts an exposure to capture the second image at a second time T2, wherein ΔT is the time between T1 and T2;
synchronizing ΔT such that ΔT is an integer multiple of at least one flicker period;
subtracting the first image from the second image to create a final image free from flicker.

2. The method for capturing an image of claim 1, wherein ΔT is an integer multiple of one of the times selected from the following group of times: 8.333 msec, 16.666 msec, 10 msec, 20, msec, 50 msec, and 100 msec.

3. The method for capturing an image of claim 1, further comprises:
stabilizing the image sensor while the first and second images are captured.

4. The method for capturing an image of claim 1, wherein the auxiliary illumination provides between 2 and 100 times the amount of ambient light.

5. The method for capturing an image of claim 1, further comprises:
determining a geographical location of the image sensor and selecting ΔT dependent on the geographical location of the image sensor.

6. The method for capturing an image of claim 1, Wherein a slew time and an exposure time is the same for capturing both the first and second images.

7. The method for capturing an image of claim 1, wherein a exposure time for capturing both images is not a multiple of the flicker period.

8. An imaging system, comprising:
an image sensor that uses a rolling shutter to capture images;
at least one illumination device; and
a controller coupled to the image sensor and the at least one illumination device, the controller capturing a first image of an object using the image sensor without using illumination from the at least one illumination device, wherein, the image sensor starts an exposure to capture the first image at a first time T1;
the controller capturing a second image of the object using the image sensor and using illumination from the at least one illumination device, wherein the image sensor starts an exposure to capture the second image at a second time T2;
synchronizing the time between T1 and T2 such that it is an integer multiple of at least one flicker period
the controller creating a final image by subtracting the first image from the second image.

9. The imaging system of claim 8, wherein the image sensor is a complementary metal-oxide-semiconductor (CMOS) sensor.

10. The imaging system of claim 8, wherein the time between T1 and T2 is a multiple of one of the times selected from the following group of times: 8.333 msec, 16.666 msec, 10 msec, 20, msec, 50 msec, and 100 msec.

11. The imaging system of claim 8, wherein the at least one illumination device provides between 2 and 100 times an amount of ambient light.

12. The imaging system of claim 8, wherein a slew time and an exposure time is the same for capturing both the first and second images.

13. The imaging system of claim 8, wherein a exposure time for capturing both images is not a multiple of the flicker period.

14. The imaging system of claim 8, further comprises:
a platen wherein the image sensor is positioned above the platen and images objects placed on the platen.

15. The imaging system of claim 8, wherein the imaging system is one of the devices selected from the following group of devices: a digital camera, a cell phone, a DPA, a laptop.
